(19) United States
(12) Patent Application Publication
(10) Pub. No.: US 2017/0069032 A1
(43) Pub. Date: Mar. 9, 2017

(54) METHOD AND APPARATUS FOR MANAGING COMPLIANCE FOR FINANCIAL TRANSACTIONS

(71) Applicant: Complii FinTech Solutions Ltd, Perth (AU)

(72) Inventor: Anthony Raymond Cunningham, City Beach (AU)

(21) Appl. No.: 15/261,817

(22) Filed: Sep. 9, 2016

(30) Foreign Application Priority Data
Sep. 9, 2015 (AU) 2015224455

(51) Int. Cl. G06Q 40/06

(52) U.S. Cl. CPC G06Q 40/06

(57) ABSTRACT

The present invention relates to a method and apparatus for managing compliance for financial transactions and financial advice. There are many regulatory requirements and regimes for the delivery of financial advice and the handling of financial transactions on behalf of clients. Failure to comply with these regimes can result in severe penalties for advisors, and disadvantage to clients. The present invention provides an apparatus and method for facilitating compliance with regulatory requirements for financial advisors. A compliance process is implemented by a computing system, and facilitates business processes that comply with the regulatory requirements.

### CROSS-REFERENCES TO RELATED APPLICATIONS

This application claims the benefit of Australian Patent Application No. 2015224455, filed Sep. 9, 2015, which is hereby incorporated by reference in its entirety for all purposes.

### FIELD OF THE INVENTION

The present invention relates to a method and apparatus for managing compliance for financial transactions and, particularly, but not exclusively, to an improved method and apparatus for managing compliance with regulatory requirements for financial advice and securities transactions.

### BACKGROUND OF THE INVENTION

Brokers and financial advisors who provide advice to clients and trade in financial products on client's behalf, are subject to strict regulatory control in most jurisdictions. In Australia, for example, an Australian Financial Services Licensee (which may include brokers or any financial advisor) are subject to strict Compliance regulations. Compliance governs how an AFSL advises the client, what operations they can take on behalf of the client, what disclosures they must make to clients, and other requirements. An AFSL must operate in the manner set out by the regulations, and must also keep comprehensive records in order to demonstrate that they are complying with the regulations.

Although some systems are known which attempt to facilitate compliance, these are generally bookkeeping systems. The arrangements currently implemented are ad hoc, often insufficiently resourced and mainly manual. Such systems are inadequate and often result in AFSL's and other advisors being in breach of regulations.

A Compliance System has been developed by the present inventors, and is known by the brand name Complii™. The Complii system facilitates the financial advice and trading process of the AFSL or other financial advisor/broker, and at the same time facilitates compliance with the regulations.

Improvements, however, to the Complii system and more generically to any system and apparatus for managing compliance, are desirable.

Other jurisdictions have financial compliance regulations, which may be similar to those in Australia. Improvements to systems which manage compliance in those jurisdictions are also desirable.

### SUMMARY OF THE INVENTION

In accordance with a first aspect, the present invention provides an apparatus for facilitating compliance with regulatory requirements for financial advisors, comprising a computing device having a processor, a memory and an operating system supporting computer processes, a compliance process arranged to facilitate business processes that facilitate compliance with the regulatory requirements, an interface process responsive to the compliance process for generating interfaces for users, and a message engine responsive to the compliance process for generating messages for communication with users, whereby users can engage with the apparatus to implement the business processes.

Financial advisors may include any financial advisor or organisation of financial advisors providing advice to clients. They may include broker companies trading in securities on behalf of clients. They may include other advisors advising on finance for clients and/or trading on behalf of clients, whether on the public stock exchange(s) or any security or any other business trade.

Clients may include any client of the financial advisor who receives advise or who the financial advisor trades on behalf of. A client may be an individual person or an organisation, such as a company, trust or any other organisation.

A user may be an individual financial advisor who needs to use the system to implement business processes relating to financial advice and trading, an administrator who may administrate an aspect of compliance (administrators may include compliance officers, for example, company officers, managers, etc.). A user may in some circumstances also include a client interfacing with the system.

The apparatus of the present invention has the advantage, at least in an embodiment, that it provides a system which forces compliance with business processes (e.g. financial trading and advice events) that comply with regulations. This contrasts with currently implemented ad hoc, mainly manual systems which tend to be inadequate and often result in breach of regulations.

In an embodiment, the apparatus comprises a Chinese Wall module, which is arranged to facilitate information barriers within an organisation, and a Chinese Wall register, the Chinese Wall module being arranged to place user data in the Chinese Wall register where the user has had access to relevant information and therefore is to be placed “behind” an information barrier.

Relevant information may be non-public information which could be considered “insider information”. Users, which may include advisors or any persons within or associated with the organisation that have access to the non-public information, are placed in the Chinese Wall register in order to isolate them from other users/persons who are unaware of the non-public information.

In an embodiment, the Chinese Wall module is arranged to control the message engine to generate a confirmation message and send it to the user who is registered in the Chinese Wall register. The message content includes content informing the user of their obligations for compliance with the information barrier status. In an embodiment, a device is generated by the Chinese Wall module which enables a user to acknowledge to the system that they have received the message and are aware that they are Chinese Wall registered. In an embodiment, the device includes a link within the message arranged to generate the acknowledgement and enter the acknowledgement in the database.

In an embodiment, the Chinese Wall module is arranged to control the message engine to send messages advising person(s) within the organisation of the Chinese Wall entry. These persons may be administrators, for example. In an embodiment, the Chinese Wall module is arranged to control the interface process to enable entry of what persons should be advised of the Chinese Wall entry.

In an embodiment, the Chinese Wall module is arranged to control the message engine to generate periodic reminders to be sent to the user entered on the Chinese Wall register to facilitate a determination as to whether or not the entry can be removed.

In an embodiment, the Chinese Wall module is arranged to monitor transactions, such as market transactions, in relation to products or user(s) registered in the Chinese Wall register or associated with the Chinese Wall entry. The Chinese Wall module is arranged to control the message engine to alert person(s) e.g. administrators if such transactions are occurring.

In an embodiment, the Chinese Wall module is arranged to monitor person(s) access to documents stored in the database which may contain non-public information, and control the message engine to generate messages to person(s) (e.g. administrator) if the documents are accessed, including data on the access to the document.

In an embodiment, the apparatus comprises an Associated Accounts module, which is arranged to locate account data for accounts which are associated with each other. For example, an individual client may have a number of accounts with an organisation, such as an individual account, a super fund account, a trust account, etc.

The Associated Accounts module advantageously enables location of all associated accounts. In an embodiment, where changes have to be made to client data, then the associated accounts module facilitates a change in the client data across all associated accounts.

In an embodiment, where a change of client data is required to be confirmed by the client, the Associated Accounts module is arranged to control the message engine 14 to generate a message to go to the client, the message including client data for the associated accounts and a request to confirm a change.

The client data change may include a change of telephone number, change of address, change of email or change of any other details.

Nowadays, it is most convenient to provide financial advice, information on trading, etc. by electronic communications. In order to comply with regulations in some jurisdictions, however, a client's consent to be advised by electronic notification is required.

In an embodiment, the apparatus comprises an electronic notifications module, which is arranged to facilitate obtaining consent from a client for electronic notification, and to log the consent.

In an embodiment, the electronic notifications module is arranged to control the message engine to generate a message to send to a client for the client to consent to electronic notification.

One of the functions of a financial advisor organisation is to provide clients with strategic advice about their finances/portfolio.

In an embodiment, the apparatus comprises a strategy module, which is arranged to facilitate the delivery of strategic advice.

In an embodiment, the strategy module is arranged to control the interface process to produce interfaces for a user to enter a record of strategic advice in the database. In an embodiment, the record includes data on how the strategic advice was delivered (e.g. by telephone, face to face, etc.).

In an embodiment, the strategy module is arranged to control the message engine to automatically prepare reminder messages and send the reminder messages to clients.

In an embodiment, the reminder messages are sent a set period from the last time a strategic advice event was entered.

In order to comply with regulations in many jurisdictions, and also in order to facilitate “good practice”, it can be important that when a client receives advice, that a record of that advice be taken.

In an embodiment, the apparatus comprises an order advice module, which is arranged to control the interface process to enable entry of records of advice by users and to control the message engine to issue advices.

The advices may be any advices associated with financial matters or financial transactions. In Australia, such advices can include Statement of Advice (SOA), a Record of Advice (ROA), Wholesale Advice or General Advice.

In an embodiment, the order advice module is arranged to group individual advices together where they are associated (e.g. they may relate to a single client). The grouped advices can be sent out as a single document, for example.

When a new account is opened for a client by an organisation various procedures should be followed and various information should be presented to the client.

In an embodiment, the apparatus comprises a Create Account module, which is arranged to facilitate the creation of an account and the presentation of information to the client.

In an embodiment, the Create Account module is arranged to control the interface process to present interfaces to users to enable the users to enter client data. This may include data such as name, address, HIN, etc.

In an embodiment, the Create Account module can be used to quickly open a Corporate Account. It can be important to open Corporate Accounts quickly so as not to impede the progress of “deals” such as Initial Public Offerings (IPOs).

In an embodiment, the Create Account module is arranged to control the message engine to create one or more messages to be sent to the client to provide them with the required advice associated with the opening of the account. The messages may include information and/or documentation such as the Financial Services Guide of the organisation (FSG) and other information/documentation.

It is important that details such as bank account details are stored in the client data and are correct and up to date. If they are not up to date, this makes it very difficult to process transactions speedily.

In an embodiment, the apparatus comprises a Reports module, which is arranged to generate reports relating to missing information, such as client data.

In an embodiment, the Reports module is arranged to generate a Report identifying missing or old bank account details.

In an embodiment, the Reports module is arranged to control the message engine to issue a message to be sent to the client requesting confirmation of the client data, such as bank account details.

In an embodiment, the user (e.g. administrator, financial advisor) can actuate the Reports module and message engine to generate the messages to go to the client.

In Australia, and other jurisdictions, it is a requirement for financial advisors to provide periodic (e.g. Annual Reports) to the clients of fees charged and services provided. In some cases, clients must “opt in” to the services provided by the organisation.

In an embodiment, the apparatus comprises a fee disclosure module which is arranged to generate an interface process enabling a user to enter fee disclosure details for a client.

In an embodiment, the Fee Disclosure module is arranged to control the message engine to generate Fee Disclosure Statements periodically. In an embodiment, the fee disclosure module is arranged to generate regular reminders for users that FDSs may be required.

In an embodiment, the Fee Disclosure module is arranged to control the message engine to generate a message to go to a client, the message including a device enabling the client to confirm that they “opt in” to services. The device may be a link which generates a message back to the apparatus, confirming “opt in” by the client.

In accordance with a second aspect, the present invention provides a method for facilitating compliance with regulatory requirements for financial advisors, comprising the steps of implementing a compliance process arranged to facilitate business processes that facilitate compliance with the regulatory requirements, generating interfaces for users, and, responsive to the compliance process, generating messages for communication with users, whereby users can engage with the compliance process to implement the business processes.

In an embodiment, the method comprises the steps of implementing information barriers within an organisation, and providing a Chinese Wall register, placing user data in the Chinese Wall register where the user has had access to relevant information and therefore is to be placed “behind” an information barrier. In an embodiment, the method comprises the step of generating a confirmation message and sending it to a user who is registered in the Chinese Wall register. In an embodiment, the method comprises the step of receiving acknowledgement from the user that they are registered behind the Chinese Wall.

In an embodiment, the method comprises the step of locating account data for accounts which are associated with each other. In an embodiment, the method comprises the further step of making a change in client data across all associated accounts, where a change is to be made to client data.

In an embodiment, the method includes the step of generating a message to send to a client for a client to consent to electronic communication, and receiving a return message from the client consenting to electronic communication.

In an embodiment, the method includes the step of generating interfaces for a user to enter a record of strategic advice into a database, and automatically preparing reminder messages regarding the need for strategy advice and transmitting reminder messages to clients.

In an embodiment, the method comprises the step of controlling an interface to enable entry of records of advice by users into a database, generating messages including advice(s) and communicating them with clients, and grouping advices together where they are associated.

In an embodiment, the method comprises the step of controlling presenting interfaces to users to enable the users to enter client data relating to the opening of a client account, and generating messages to be sent to the client to provide them with required advice associated with the opening of the account.

In an embodiment, the method comprises generating reports relating to missing information and controlling an interface to present the reports to a user, and generating messages to be sent to clients requesting confirmation of missing/updated client data.

In an embodiment, the method comprises the step of generating an interface enabling a user to enter fee disclosure details for a client, and generating Fee Disclosure Statements and messages to send the Fee Disclosure Statements to clients.

In accordance with a third aspect, the present invention provides a computer program, comprising instructions for controlling a computer, to implement an apparatus in accordance with the first aspect of the invention.

In accordance with a fourth aspect, the present invention provides a computer readable medium, providing a computer program in accordance with the third aspect of the invention.

In accordance with a fifth aspect, the present invention provides a data signal, comprising a computer program in accordance with the third aspect of the invention.

In accordance with a sixth aspect, the present invention provides an apparatus for facilitating compliance with regulatory requirements for financial advisors, comprising a computing device having a processor, a memory and an operating system supporting computer processes, a Chinese Wall module, which is arranged to facilitate information barriers within an organisation, and a Chinese Wall register, the Chinese Wall module being arranged to place user data in the Chinese Wall register where a user has had access to relevant information.

In accordance with a seventh aspect, the present invention provides an apparatus for facilitating compliance with regulatory requirements for financial advisors, comprising a computing device having a processor, a memory and an operating system supporting computer processes, an associated accounts module, which is arranged to locate account data for accounts which are associated with each other, and to facilitate a change in client data across all the associated accounts.

In accordance with an eighth aspect, the present invention provides an apparatus for facilitating compliance with regulatory requirements for financial advisors, comprising a computing device having a processor, a memory and an operating system supporting computer processes, an electronic notifications module, which is arranged to facilitate obtaining consent from a client for electronic notification and to log the consent in a database, the electronic notifications module being arranged to generate message(s) to send to a client for the client to consent to electronic notification.

In accordance with a ninth aspect, the present invention provides an apparatus for facilitating compliance with regulatory requirements for financial advisors, comprising a computing device having a processor, a memory and an operating system supporting computer processes, a strategy module, arranged to control an interface to produce interfaces for a user to enter a record of strategic advice in a database, and to automatically prepare reminder messages and send reminder messages to clients regarding a requirement for updated strategy advice.

In accordance with a tenth aspect, the present invention provides an apparatus for facilitating compliance with regulatory requirements for financial advisors, comprising a computing device having a processor, a memory and an operating system supporting computer processes, an order advice module, arranged to enable entry of records of advice by users into a database, and to issue messages to send for communication with clients, containing advices.

In accordance with an eleventh aspect, the present invention provides an apparatus for facilitating compliance with regulatory requirements for financial advisors, comprising a computing device having a processor, a memory and an operating system supporting computer processes, a Create Account module, which is arranged to facilitate the creation of an account for a client and the presentation of information to the client, and is arranged to control an interface to present interfaces to users to enable users to enter client data to open an account, and to generate message(s) to be sent to the client to provide them with required advice associated with the opening of the account.

In accordance with a twelfth aspect, the present invention provides an apparatus for facilitating compliance with regulatory requirements for financial advisors, comprising a computing device having a processor, a memory and an operating system supporting computer processes, a reports module arranged to generate report(s) relating to missing client data, and to generate message(s) to be sent to clients requesting confirmation of missing/updated client data.

In accordance with a thirteenth aspect, the present invention provides an apparatus for facilitating compliance with regulatory requirements for financial advisors, comprising a computing device having a processor, a memory and an operating system supporting computer processes, a fee disclosure module arranged to generate interfaces enabling a user to enter Fee Disclosure details for a client, and generate messages including information such as Fee Disclosure Statements.

In accordance with a fourteenth aspect, the present invention provides a computer program, comprising instructions for controlling a computer to implement an apparatus in accordance with any one of the sixth to the thirteenth aspects of the present invention.

In accordance with a fifteenth aspect, the present invention provides a computer readable medium, providing a computer program in accordance with the fourteenth aspect of the invention.

In accordance with a sixteenth aspect, the present invention provides a data signal, comprising a computer program in accordance with the fourteenth aspect of the invention.

### BRIEF DESCRIPTION OF THE DRAWINGS

Features and advantages of the present invention will become apparent from the following description of embodiments thereof, by way of example only, with reference to the accompanying drawings, in which:

FIG. 1 is a schematic diagram of an apparatus in accordance with an embodiment of the present invention;

FIG. 2 is a flow diagram illustrating operation of an embodiment of the present invention;

FIGS. 3 to 12 are schematic representations of interfaces and documents provided by an embodiment of the present invention;

FIGS. 13 and 14 are flow diagrams illustrating operation of embodiments of the present invention;

FIG. 15 is a representation of a message document provided by an embodiment of the present invention;

FIG. 16 is a flow diagram illustrating operation of an embodiment of the present invention;

FIGS. 17 to 36 are representations of interfaces and documents provided by embodiments of the present invention.

### DETAILED DESCRIPTION OF EMBODIMENTS OF THE INVENTION

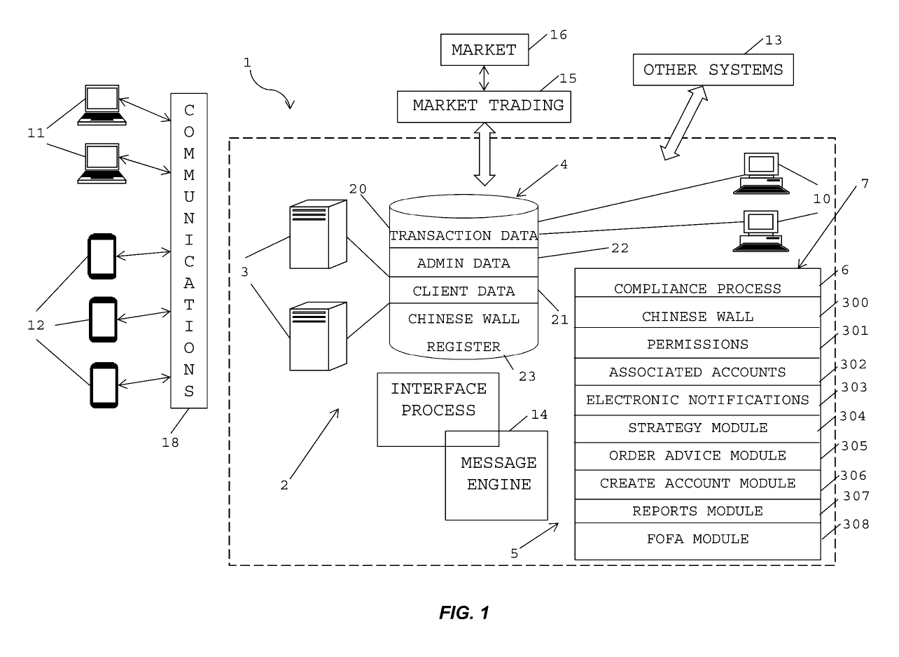

A Compliance system in accordance with an embodiment of the present invention is illustrated schematically in FIG. 1. The Compliance system, generally designated by reference numeral 1, comprises a computing system 2. In this example, the computing system 2 comprises one or more servers 3, comprising processors and memory capacity. The servers 3 may be supported by the organisation administrating the system. Alternatively, the system may be supported remotely, for example in the “cloud”.

Computing system 2 incorporates hardware and software which provides and supports various computer processes 3. A database 4 is also supported by the computing system 2. The computer processes 5 comprise a compliance process 6. The compliance process 6 provides a number of functions facilitating compliance for financial services and transactions within the appropriate jurisdiction's regulatory regime. The compliance process 6 comprises a number of functional modules 7, which will be described in more detail later.

The processes 5 also include an interface process 8 which is arranged to generate interfaces which can be accessed by a computing device in order to enable interaction with the system 2. For example, computing devices may comprise administrator computing devices/terminals 10 which may be connected via a communications link with the computing systems 2. The system also comprises communications circuitry 11 which is able to communicate over networks (e.g. the internet or any other network) to computing devices 11, 12, which may comprise mobile computing devices or smart phones, tablet computers, laptops, PC's. Interfaces may therefore be generated by the interface process 8 which can be accessed by mobile devices 11, 12, devices 10 or any other device (PC's or any digital device) from a remote location via a communications network 18 or within the organisation via an internal network (devices 10, for example).

In this embodiment, the system 1 is a web based, ASIC data retention compliant system. The compliance processes 6 are designed to automate, check and process an AFSL's compliance obligations, including those of its staff members. The database 4 is based on SQL. The processes are arranged to interface and extract data from other systems 13 that the AFSL may use. Such as IRESS, GBST advisor, ETRADE, and any other systems.

The computer processes also comprise a message engine 14 which is arranged to generate messages which can be sent to devices 10, 11, 12. Messages may include compliance documents, compliance alerts, and any other message.

As discussed above the system 2 may receive data from other systems 13 (either by extraction or feed from those other systems). They may also receive data from market trading systems 15 which are arranged to trade on a stock market system 16, for example. Data feeds from market trading system 15, for example, may be fed into the compliance system to enable monitoring of transaction data.

The computer processes 5 may be implemented as separate modules, which may share common foundations, such as routines and sub-routines. The computer processes may be implemented in any suitable way and are not limited to the separate processes, engines and modules as illustrated in FIG. 1. Any software/hardware architecture that implements the functionality described in this specification may be utilised.

The database 4 may be based on SQL and partitioned in any convenient way. The database includes transaction data 20, including data on financial transactions which may occur on or off-market. It also includes client data 21, which may include client account data, client transaction data and any other data relating to a particular client of the financial services provider utilising the system 2. The database 22 may also include administration data, including data on administrators with permissions to access the system 2. The administrators may be individual financial advisors of the AFSL or other organisations administrating the system 2, for example. The database 4 also implements Chinese Wall register 23, in this example, which records Chinese wall entries and operations (see later on in this description).

Embodiments of the invention are not limited to being implemented by servers or in the cloud. Embodiments may be implemented by a variety of hardware and software architecture. General purpose computers may be programmed to implement the apparatus and method. Any architecture could be implemented, including client/server architecture, central processing unit/terminal architecture or any other architecture. The system may be implemented utilising mobile devices, such as tablet computers and laptop computers, or dedicated bespoke architecture. Software may be used to program processors to implement the embodiments of the invention. Programmable hardware may be used to implement embodiments, such as field programmable gate arrays, programmable gate arrays, and any other hardware.

In this embodiment, the compliance system 1 provides a number of compliance functions:
Manages the issue and management of Financial Services Guides (FSG) of service providers, Statements Of Advice (SOA) and Records Of Advice (ROA);
Electronic Chinese wall register(s), monitoring and management;
Provides reports across the database and system;
Conflict of interest register based on ASIC RG181;
Manages the reporting and recording of electronic fee disclosure and automated feed to all advice event documents;
Small benefits register;
Integrated risk management and compliance monitoring programs;
Breach reporting and register;
Hosting of compliance operational policies and procedures;
Corporate transactions (off-market) including bulk issue of electronic offer letters, automated acceptance forms and online processing of application monies;
Management of expiry and renewal of all sophisticated investor or wholesaler investor certificates;
Other compliance functions may also be managed and implemented by the system 1.

### Information Barriers

The system 1 is arranged to implement a Chinese Wall module 300. This allows AFSL's to register themselves or advisors as behind a Chinese Wall where required. The message engine 14 is then arranged to generate an email confirmation that the advisor(s) is behind the wall. The message engine email 14 will also inform the obligations of the persons behind the wall.

In general all financial advisors and financial advisor firms are required to develop, implement and enforce reasonable policies and procedures to safeguard “insider information” and to ensure no improper trading occurs. Persons with “insider information” (non-public information) may be placed behind Chinese Walls to isolate them from other advisors/persons who are not aware of the non-public information. Those behind the Chinese Walls will not be able to trade in or undertake any advice relating to the non-public information or the entity associated with the non-public information. Those outside the walls may still be able to trade or offer advice in that entity.

The Chinese Walls effectively restrict the flow of information between people within an organisation. These provide important safeguards against breaches of the provisions relating to insider information. Chinese Walls are also known as “Information Barriers”, being policies and systems which are implemented by organisation to restrict the flow of information.

Basic elements of Chinese Walls which must be adhered to at all times are:
1. Communication of non-public information to Advisors/Employees who advise or trade on behalf of clients or the AFSL is strictly prohibited.
2. Access to documents, including computer records, which may contain non-public information should be restricted and the restriction monitored.
3. Where as a result of its relationship to a client, the AFSL or an Advisor/Employee is in possession of information that is not generally available in relation to a product (e.g. a security) and which would be likely to materially affect the price of that Security if the information was generally available, the Advisor shall not give any advice to any other client of a nature that would damage the interest of either of those clients.
4. The AFSL shall not be regarded as having possession of information that is not generally available in relation to a Security where it has Chinese Walls in place and the person advising the client is not in possession of that information. The AFSL or any other advisor can therefore continue to provide client advice and trade in a product such as a security, as long as the appropriate Chinese Walls are in place and the person who has the non-public information is behind the Wall and not dealing in the product.

In this embodiment, the compliance process 6 comprises a Chinese Wall module 300. The Chinese Wall module 300 works with the interface process 8 to provide templates which enable entry of Chinese Wall data into the Chinese Wall register 23. The Chinese Wall data may include data of employees (administrators/advisors/etc.) who are in possession of non-public information and need to go “behind” a Chinese Wall. The data is entered in the Chinese Wall register 23.

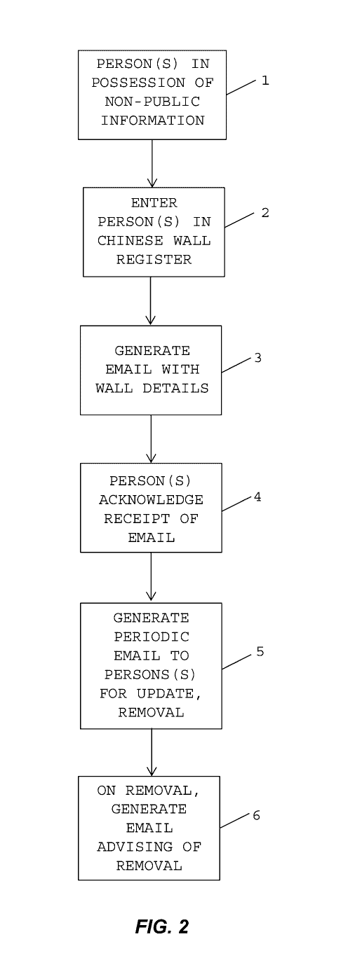

FIG. 2 is a flow diagram illustrating generally operation of the Chinese Wall module 300 and Chinese Wall register 23 within the system 1. At step 1, when a member of the organisation (e.g. a financial advisor) comes into possession of non-public information they immediately report the matter to a compliance administrator (usually another member of staff or an officer of the organisation) and cease to advise on or commence advice or trade in the relevant securities. An entry is made via devices 10, 11 or 12 and interfaces 8 into the Chinese Wall Register 23 (step 2). This will include the date, the name of the individual who is in possession of the information, the name of the company and if it is an internal or external entry. This forms part of the Chinese Wall Data.

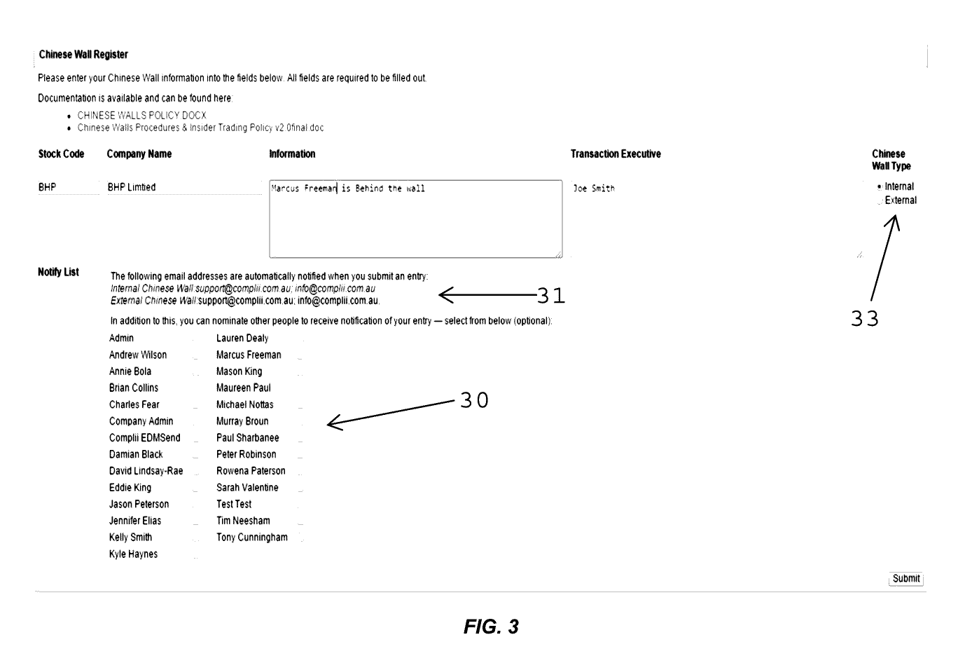

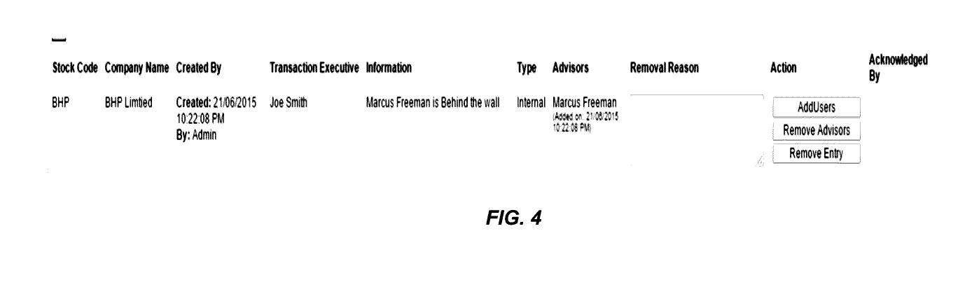

FIG. 3 illustrates a template generated by interface process 8 in response to Chinese Wall module 300, enabling an operator to enter Chinese Wall Data. In this case an advisor has come into possession of relevant non-public information and must be placed behind a Chinese Wall. FIG. 4 shows an interface view of a Chinese Wall record from the Chinese Wall register 23 when the entry has been made.

Using the interface template shown in FIG. 3, the administrator can select who will be notified of the Chinese Wall entry (reference 30). The interface process 8 will in any event automatically notify administration (reference 31). When Chinese Wall entry is made, the message engine 14 generates emails and sends those emails to the nominated persons 30 and administration 31, advising them of the entry in the Chinese Wall.

FIG. 4 shows the entry in the entry in the Chinese Wall register 23 following entry into the template of FIG. 3.

Where personnel have been taken over the Chinese Wall because of an impending corporate role involving the organisation, the entry will be registered as an Internal Chinese Wall entry. Other corporate members inside the Chinese Wall will be able to see these entries. Where the person(s) is in possession of information that is not related to the organisation (but is non-public information which is concerned with a security) the entry will be made on the register as an External Chinese Wall entry. These will not be visible to anyone else in the organisation other than the administrative staff. See reference 33 in FIG. 3.

“Permissions” are controlled by the interface template and the interface process 8 so that only notified persons are allowed to view the Chinese Wall entry.

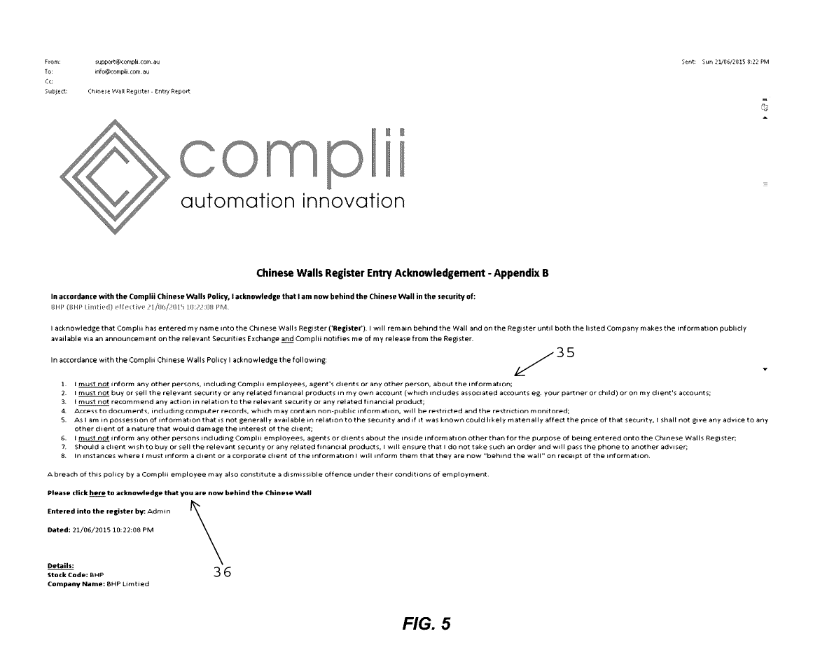

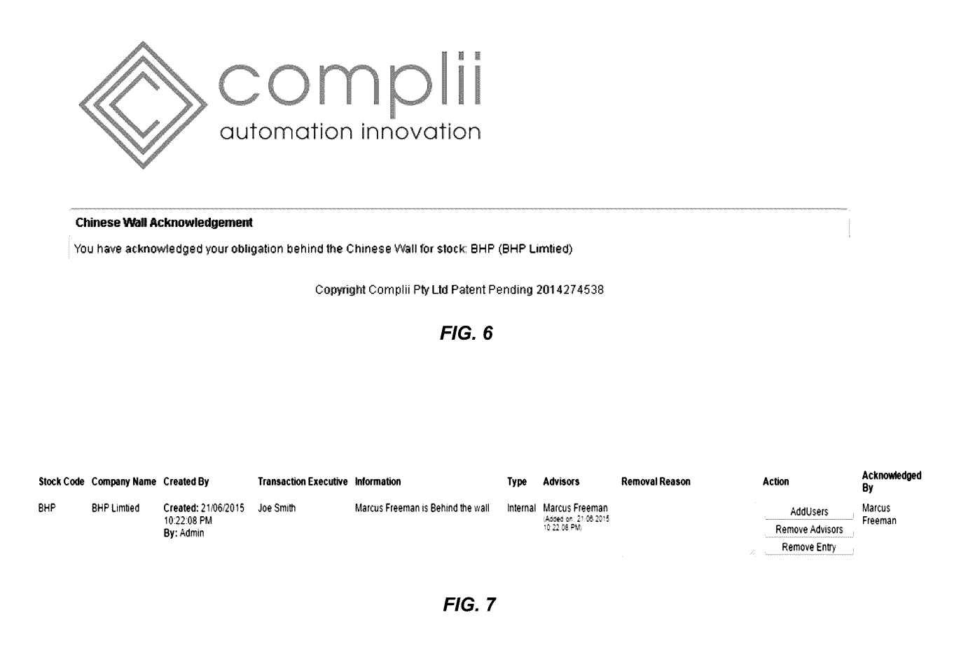

As an entry is made concerning a person, then the message engine 14 generates an email to go to that person including the details of the entry. See FIG. 5 for an example email. The email includes information on the obligations of the person behind the Chinese Wall (reference 35). It also includes a link (reference 36). Operation of the link 36 causes transmission to the Chinese Wall register 23 that the person has acknowledged their commitment. See FIG. 6 for an interface generated by the interface process 8 in response to actuation of the link 36 in the email. FIG. 7 shows the entry in the Chinese Wall register 23 following acknowledgement by the person of their obligations (reference 38). See also step 3 and 4 of the process diagram in FIG. 2.

The system 1 in this embodiment is web based and can be accessed via communications 11 and remote mobile devices 11, 12. The interface process 8 and message engine 14 are arranged to adapt interfaces and messages for mobile or conventional computer display.

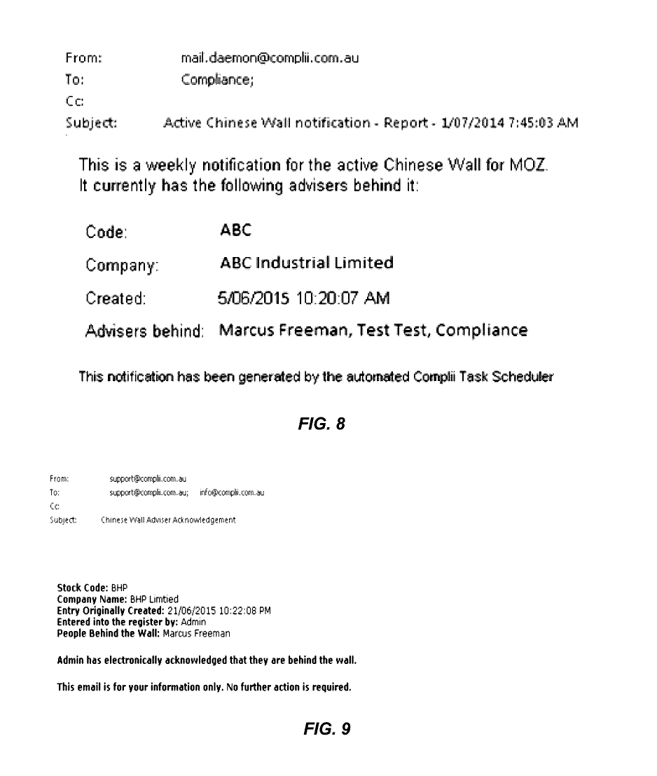

Referring again to FIG. 2, at step 5, messages are generated periodically by message engine 14, in the form of emails, to remind person(s) that they are behind a Chinese Wall and determine whether or not the Chinese Wall entry can be removed. FIG. 8 illustrates the type of email that may be sent to the administrative division of the organisation reminding them that advisors are behind a Chinese Wall. A similar email is sent to the person(s) behind the wall.

On response from the person(s) or on input from administration division, via the interface process 8, a person(s) may be removed from the Chinese Wall. For example, if the non-public information has now been made public (e.g. by press release or any other publication) then the person(s) can come from behind the Chinese Wall.

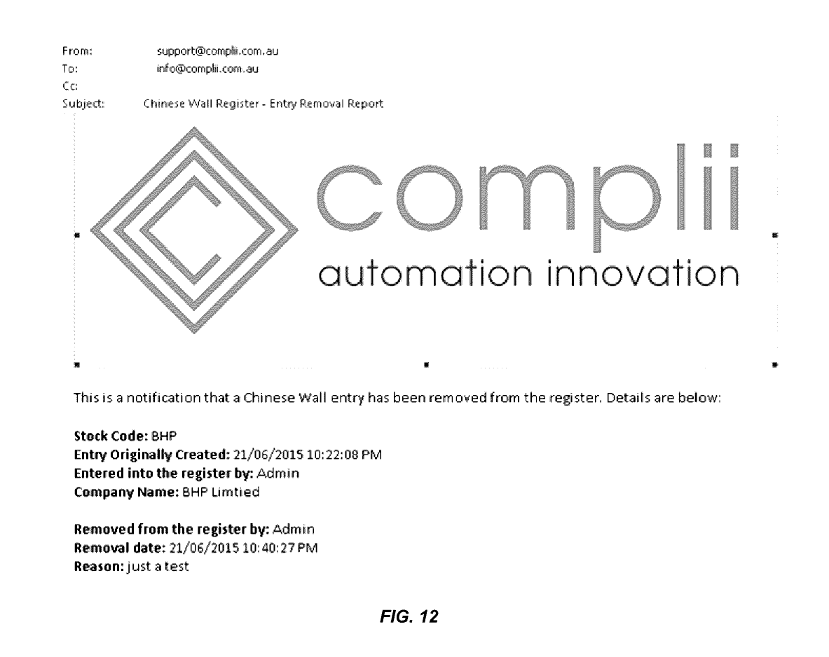

On removal, the message engine 14 generates a message (in this embodiment via email) advising that the person(s) has been removed from behind the Chinese Wall. The message may be sent to the administrative division and also to the person concerned. An illustration of a message that might be sent is shown in FIG. 12.

FIG. 9 shows an example email generated for Administration to confirm that a person(s) has acknowledged that they are behind a Chinese Wall.

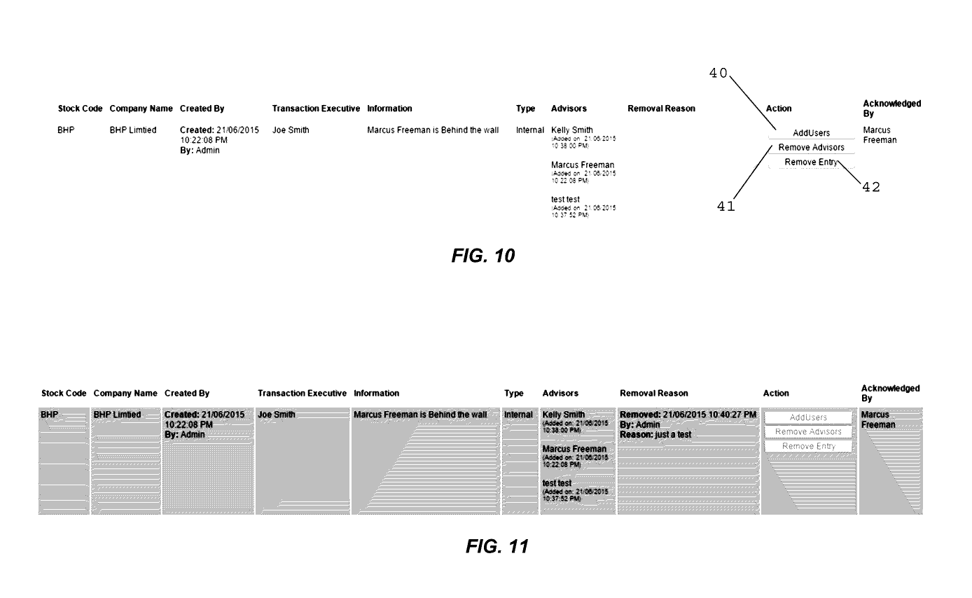

FIG. 10 shows an interface template 8 showing an entry on the Chinese Wall register 23. Chinese Wall persons may be added by clicking on the “AddUsers” button 40. An email for the user to go behind the Chinese Wall will be generated in each case.

Persons behind Chinese Walls can be removed one by one (see Remove Advisors button 41) or the entire entry can be removed from the Chinese Wall (Remove Entry button 42), should there no longer be need for the Chinese Wall for that matter. Where the entire event is removed, then it will be moved to “hidden entries” and shaded as shown in FIG. 11.

A permissions module (301) is arranged to enable setting of permissions for persons to have access to various levels of information in the database 20 and to be alerted/advised via messages from message engine 14. Organisations which are involved in financial advice and trading have various structures but will usually have a team (e.g. a “compliance team”) whose responsibility is to manage and be aware of aspects of the organisation such as Chinese Wall data. For example, it may be important for the compliance team to see what stocks are a behind a Chinese Wall and if they are internal stocks or external. For example, a team responsible for corporate transactions may be required to see the internal Chinese Wall entries but not the external wall entries. Permissions 301 may therefore be set to advise the compliance team of all stocks behind the Chinese Wall and person(s) behind the Chinese Wall, and also changes in the Chinese Wall data (person(s) coming out from behind the Chinese Wall, stocks coming out from behind the Chinese Wall, etc.). The corporate team will have permission to see internal Chinese Wall entries, but not external ones.

The permissions module 301 allows the system 1 to be configured to give various access to different person(s)/departments in an organisation.

The Chinese Wall module 300 is also arranged to monitor the placing of orders and the transacting of orders in relation to stocks/person(s) behind a Chinese Wall and alert person(s) with the appropriate permissions (e.g. the compliance team) via the message engine 14, if such transactions are occurring. There are a number of scenarios where the compliance team may be required to be alerted of trades, for example:
If a financial advisor placed an order in a stock that he or she is behind the wall in, then it is important that the compliance team is notified that this advisor or any other staff member (behind the wall or not) is trading in the stock.
If an advisor placed an order some time ago (e.g. one month) then went behind the wall later, then it is important that the compliance team is notified that trade in the stock occurred.
It is important that the compliance team is alerted if anyone in the office is trading in a Chinese Wall stock regardless of if they are behind the wall or not. In this case the compliance module monitors all trading in the stock.

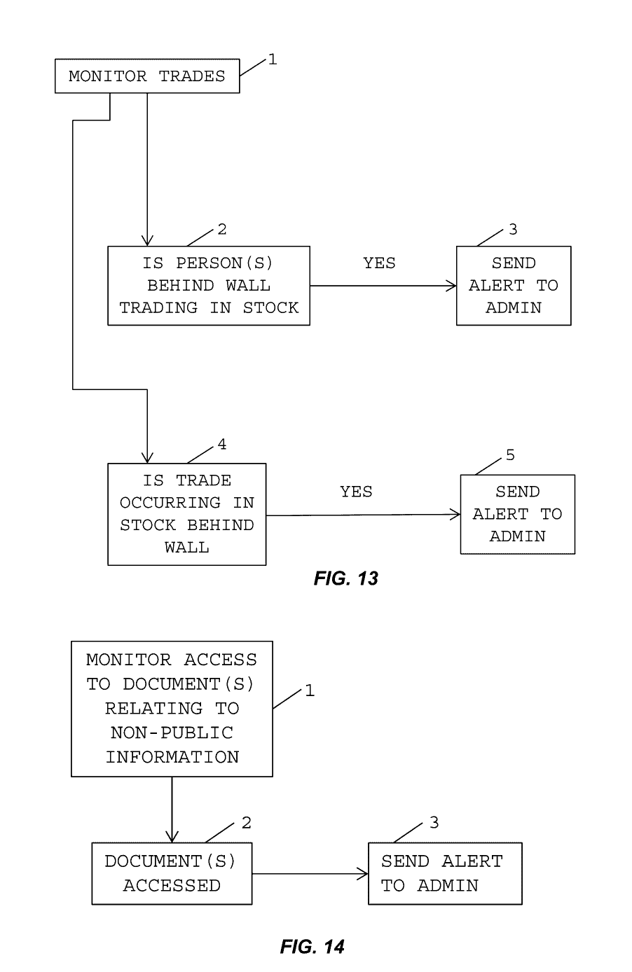

Referring to FIG. 13, the compliance module is arranged to monitor trades (step 1). If a person who is behind a wall is trading in a stock (step 2) then an alert email may be sent to administration (step 3). If a trade is occurring in a stock behind a wall (step 4) then an alert email is also sent via the message engine 14 to admin (e.g. compliance team) (step 5).

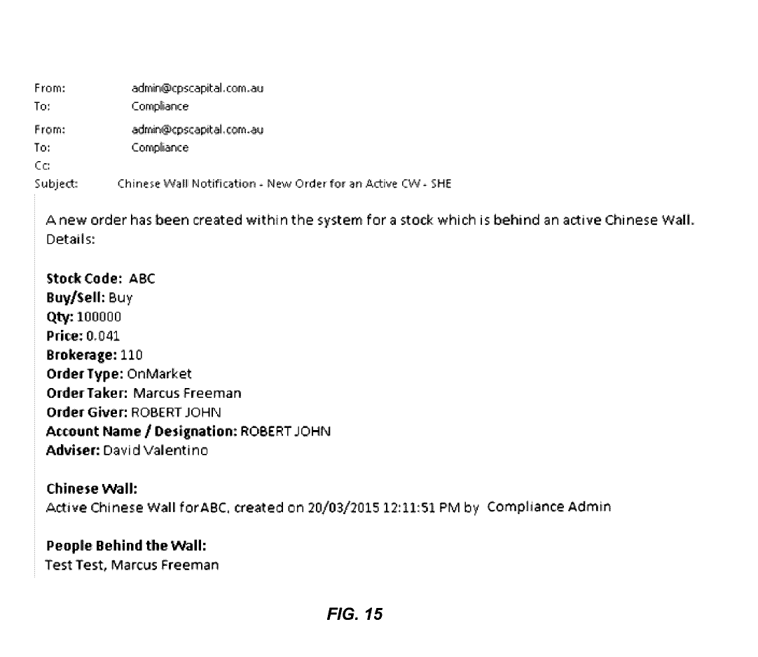

FIG. 15 illustrates an email message that may be sent to the compliance team advising of trading within a stock behind a Chinese Wall.

Advantageously, this means that administration (and any other persons with appropriate permission) will be automatically advised by an automated message from the message engine 14, should trading occur in stocks/by person(s) behind Chinese Walls. They will therefore be able to take appropriate action.

In another aspect of the Chinese Wall module 300, access to documents which may be stored on the system 1 (in database 4) and which contain non-public information, may be monitored (step 1 FIG. 14). If documents are accessed (step 2), an alert message is generated by message engine 14 (step 3). A compliance team, for example, may therefore be alerted to the fact that non-public information has been accessed on the system 1, and directed to the person(s) accessing the non-public information.

The system 1 is arranged to log all messages, and transactions (e.g. in the Chinese Wall register) and keep them in the database 4 so that they can be accessed for compliance purposes. For example, if a governing authority wishes to determine that Chinese Wall provisions are sufficient, or look into a particular case, complete records will be available from the database 4 of all transactions, messages and data.

### Change of Address/Associated Accounts

If there is a change of client details, it is important that the detail change be recorded, and that the details be confirmed by the client.

Often, clients may have a number of different accounts. For example, they may have a personal account, a managed superfund account, a trust account and other accounts. Having to manage client details for all these different accounts is complex, and time consuming. For example, if address details need to be updated, currently they need to be updated for each separate account, even where the accounts may be associated with the same client.

A feature of this embodiment is an Associated Accounts module 302. Where there is a change of client details, it is possible to immediately locate associated accounts (associated with that client) and therefore deal with the change for all accounts at once.

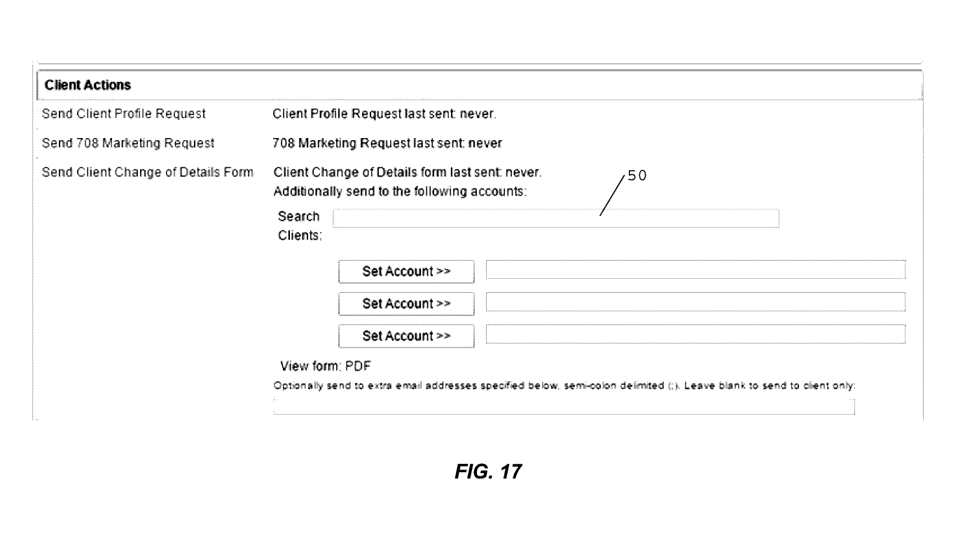

Referring to FIG. 17, when the client details are changed, the interface process 8 is arranged to generate a form as shown in FIG. 17. A Search Clients box 50 enables searching of associated accounts for a client. The database is searched for all linked accounts.

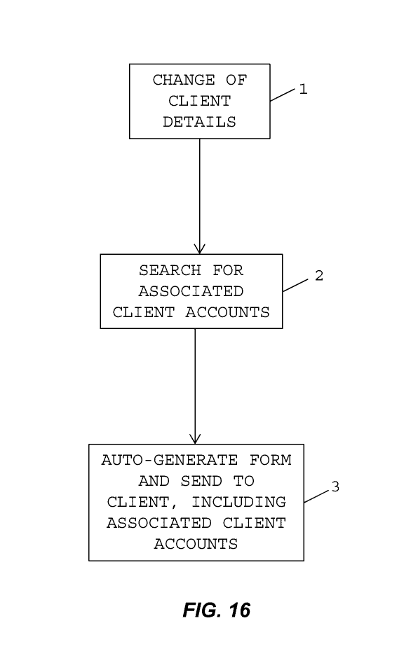

See FIG. 16. At step 1, a change of client details is required so the FIG. 17 interface is brought up. A search for associated client accounts is carried out (step 2). Then, at step 3, a form is auto-generated by message engine 14 and sent to the client via communications 11.

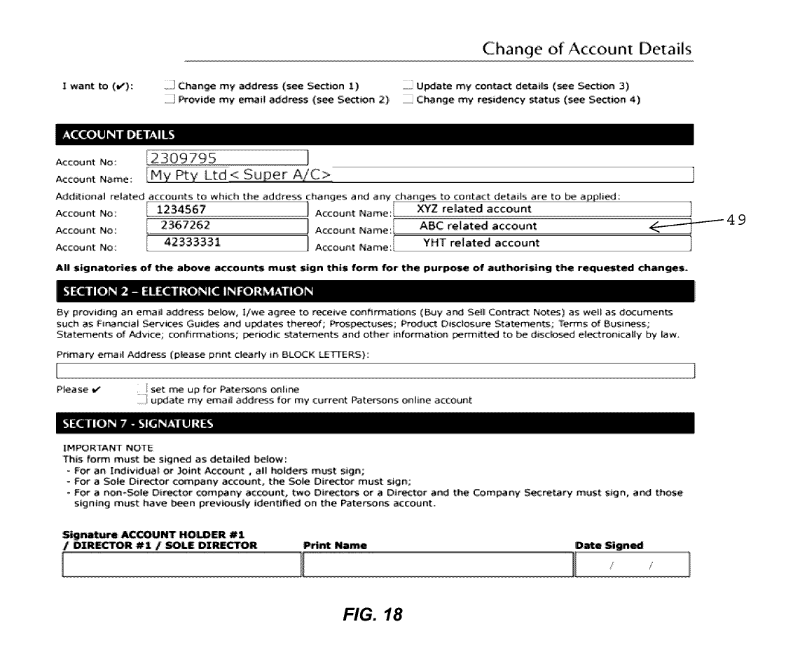

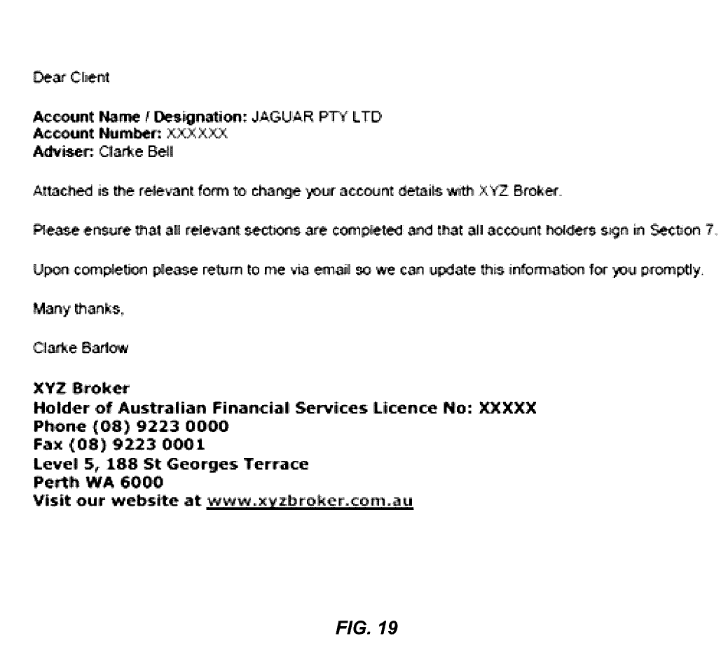

An example form is shown in FIG. 18. It can be seen that at 49 a number of related accounts are cited in the form and therefore all details can be updated simultaneously. FIG. 19 illustrates an example email which may go to the client with the form.

The ability to capture associated accounts and automatically message clients for changes of details with the associated accounts, advantageously saves time and ensures that records are kept up to date across multiple accounts.

### Electronic Consent

If a financial advisor/broker wishes to communicate electronically with a client regarding transaction information, then the client's consent is required for electronic notification. This consent must be obtained and logged, in order to ensure compliance with the regulations.

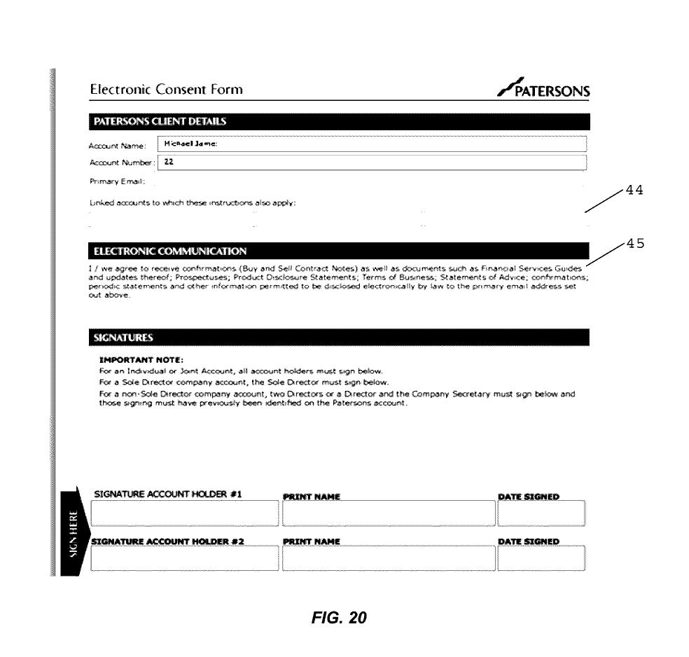

In this embodiment, an electronic notifications module 303 is arranged to deal with electronic consent. The electronic notifications module 33 is arranged to control the message engine 14 and interface process 8 to generate Electronic Consent Form 4 such as illustrated in FIG. 20. The form can automatically be filled in with associated accounts (reference numeral 44) via the associated accounts module 302. The form is emailed to the client for signature and return via communications 18. The Electronic Communication Notification is included in the form (reference numeral 45).

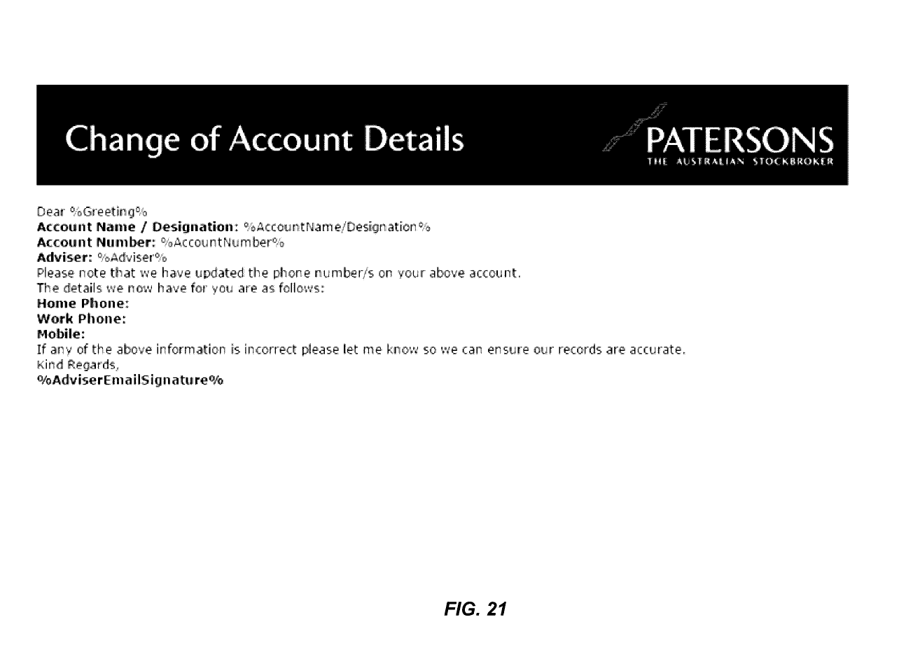

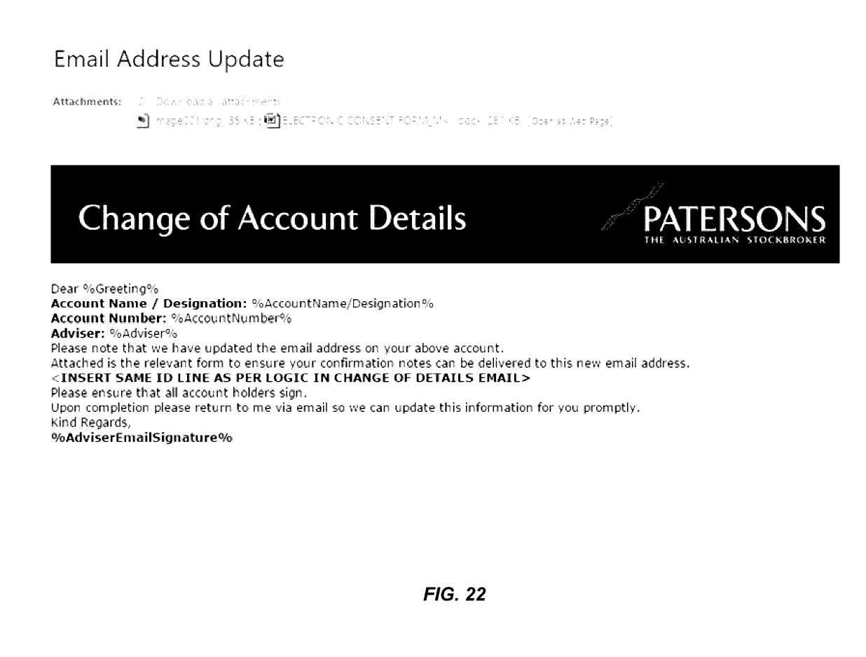

Phone details, email details, and other account details may be updated at the same time by generation of an email message to go with the Electronic Consent Form of FIG. 20. For example, in FIG. 21, an email message dealing with phone number update is illustrated. In FIG. 22, an email message dealing with email update. These are automatically generated by the message engine 14 in response to change of account details.

### Strategic Advice

One of the functions of a financial advisor organisation is to provide clients with strategic advice about their finances. For example, for private clients, financial advisors may be required to regularly provide strategic advice on investments and regularly update that advice.

In order to comply with regulations in some jurisdictions, an advisor must regularly update the strategic advice, to make sure that it is current. This is also, in any event, good practice.

The system 1 includes a strategy module 304 which is arranged to store records and Strategic Advice events and also to automatically generate reminders, reminding advisors that they must update strategic advice.

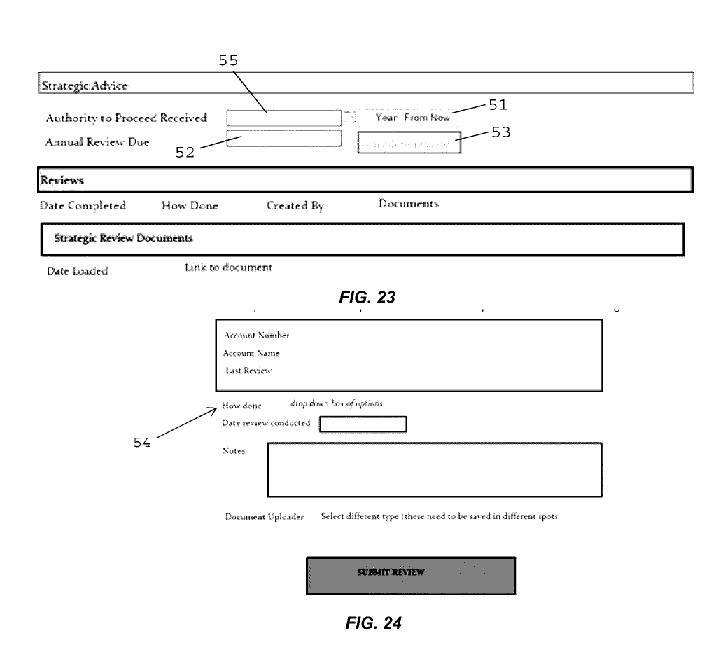

In this embodiment, the interface process 8 is arranged to generate an interface template in accordance with FIG. 23 to take a record of a Strategic Advice event.

Following a strategy review with a client, an advisor accesses the template of FIG. 23 and fills in a date in the Authority to Proceed Received box 55. The Year from Now button 51 is then clicked and this fills in a date in the Annual Review Due box 52 a year from when the Authority to Proceed was received.

Permissions Module 301 may set permissions for person(s) who can amend or enter in the Strategic Advice template. For example, amendment of the Authority to Proceed and Annual Review Date Due may only be enabled for administration.

The Complete Review 53 is open only for the financial advisor and when they click on the button 53 the interface process 8 generates the template shown in FIG. 24. This enables the advisor to fill in details of the review on the system. The “How Done” button 54 enables a drop-down box of menu items for the advisor to select how the review is carried out. These may include, for example, face-to-face meeting; email updates; phone call; review declined, etc.

If the review is declined, the Submit Review button can be pressed. All other fields grey out and cannot be filled in. Otherwise the other fields can be filled in so that the system 1 has a record in the database 4 of the review. The annual review date then automatically updates 12 months from when the review was conducted.

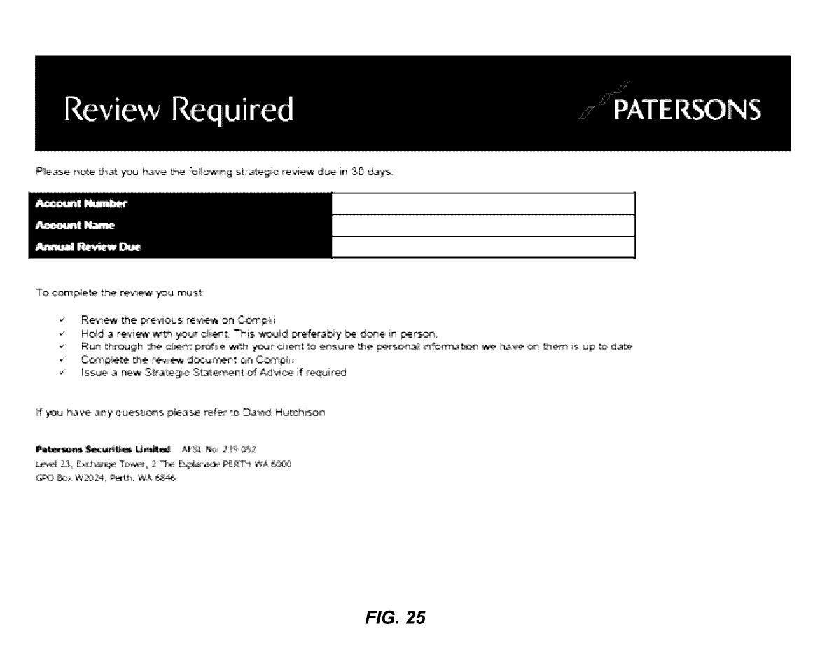

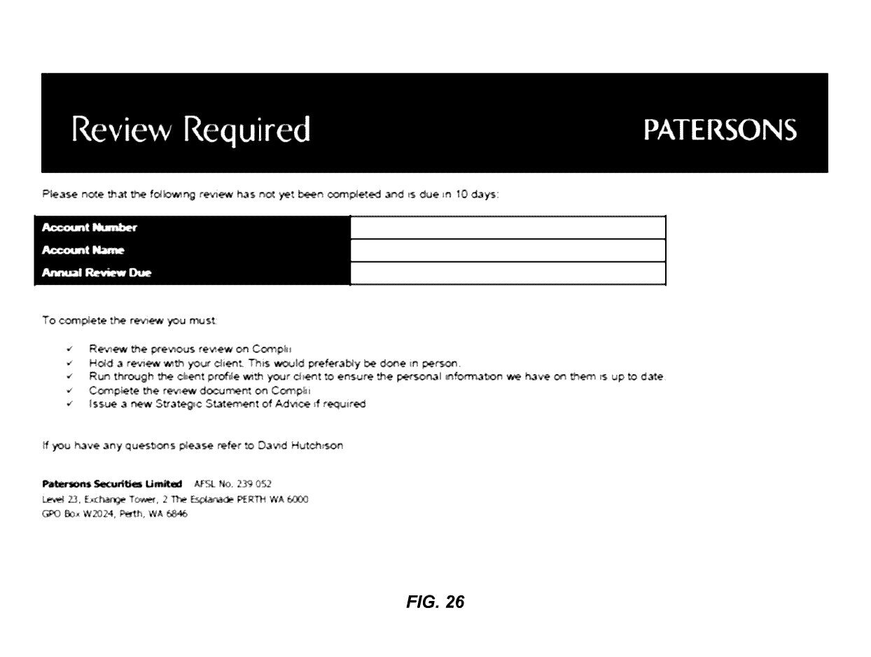

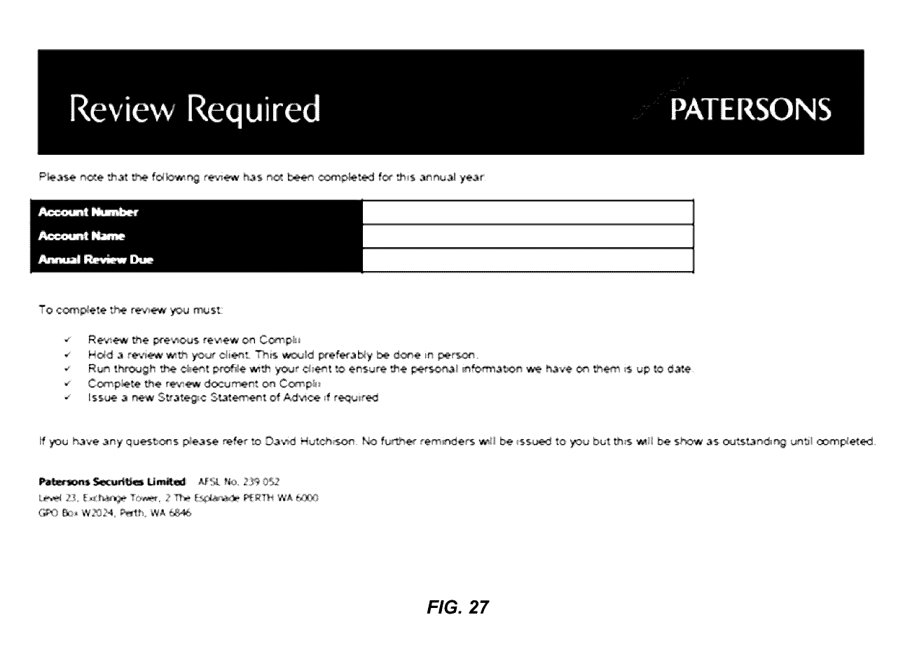

The strategy module 304 is arranged to control the message engine 14 to generate email reminders when the next review is due. Three example reminders are shown in FIGS. 25, 26 and 27, each to be issued at different times. It is important where an advisor has many clients, that they be reminded of the periodic review requirement. Having an automated system such as disclosed in this embodiment, which may automatically send messages to mobile devices or other devices of advisors has significant advantages in ensuring that they comply with the requirements for updating a strategic review for their clients.

### Order Advice Module

When implementing financial advice and trades for a client, it is important that the client be advised, even when the client has instructed the financial advisor to act on their behalf in these matters in accordance with their strategic approach to investments. It is also required by regulations (at least in Australia, and other jurisdictions) that advice be issued. When a transaction occurs, it is necessary to issue advice of the transaction occurring, for example. This may be done as a Statement of Advice (SOA), a Record of Advice (ROA), wholesale advice or general advice. Currently, such an advice is issued one at a time, for each stock that may be traded in, for example.

In the present embodiment, an Order Advice module 305 is arranged to instruct the message engine 14 and interface process 8 to “wrap up” advices together. This has an advantage that only one document needs to be sent out for a multiple advice event. For example, one document could be sent out for ten stocks bought and sold.

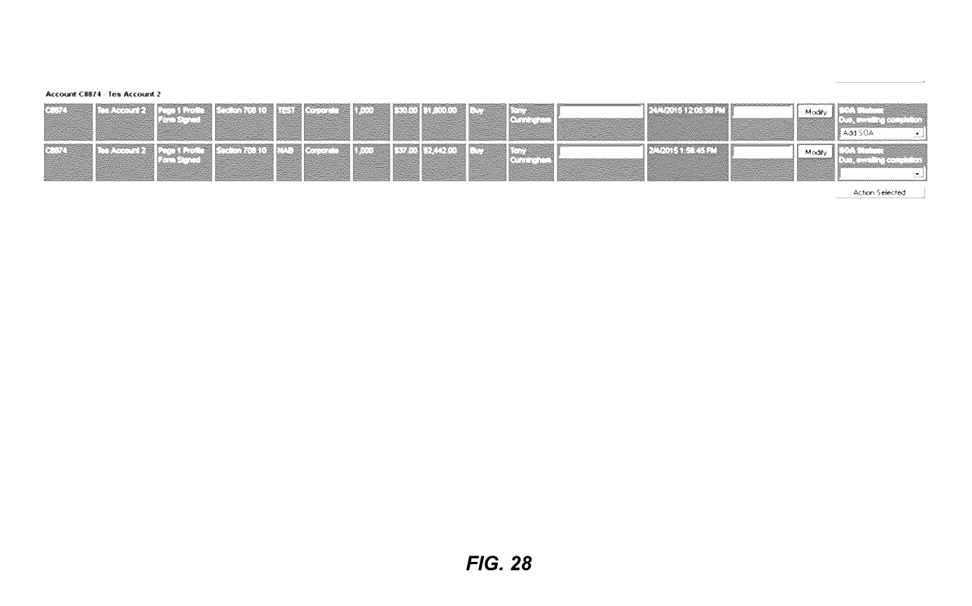

FIG. 28 is an interface template produced by the interface process 8 which shows that two orders can be wrapped up and two brokerage amounts added together to be imported into a SOA.

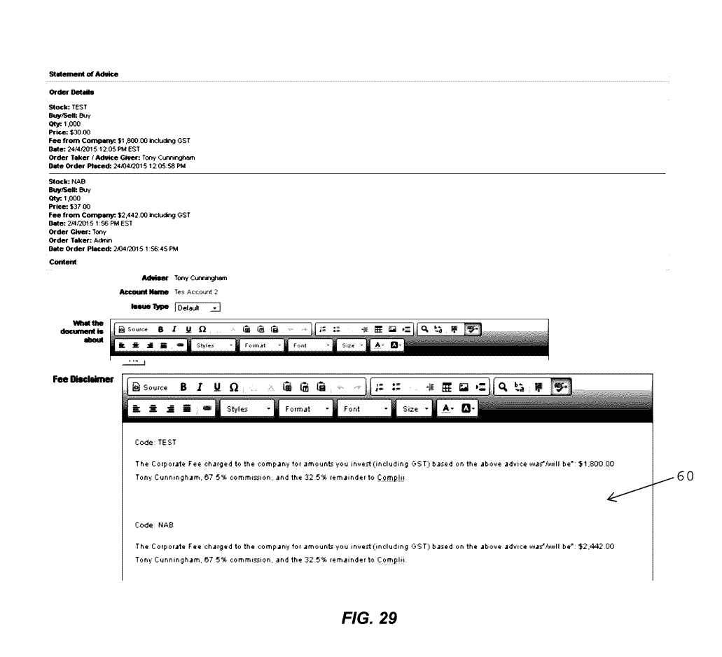

FIG. 29 shows the Statement of Advice to be sent to the client by the system 1. It can be seen that the two orders are wrapped up into the single SOA and the brokerage fees added together to the SOA (reference numeral 60).

### Create Corporate Account

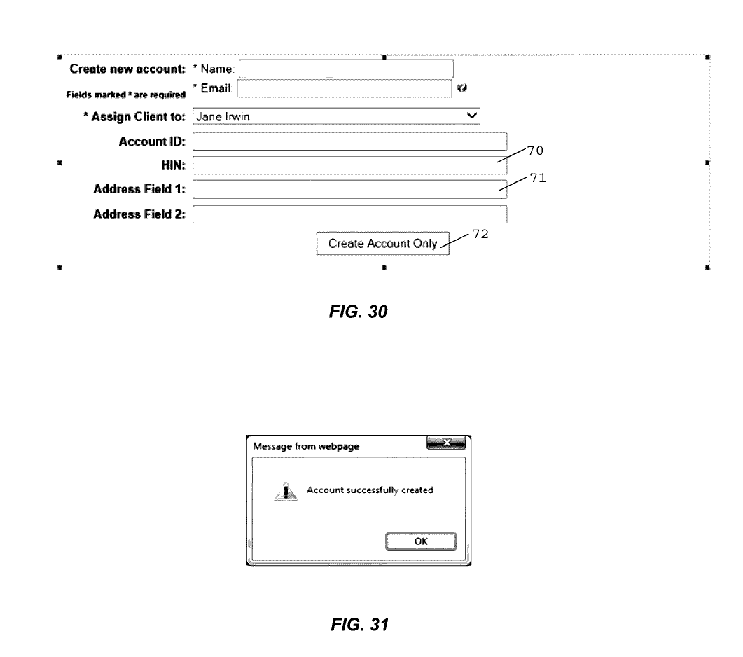

When a new account is created for a client, it is important that various procedures be followed and documents be presented to the client. The present embodiment includes a Create Account module 306 that facilitates the creation of new accounts. In response to the Create Account module 306, the interface process 8 produces the interface template illustrated in FIG. 30. The advisor is able to fill in the required details for opening of the account, as illustrated in FIG. 30. This interface may be used to open a Corporate Account. Where a deal is pending (e.g. a share issue), it is important that new Corporate Accounts be opened very quickly. As well as Name and Email, the interface shown in FIG. 30 also includes HIN 70 and Address 71 fields. Pressing the Create Account Only button 72 results in the documents being generated that are required to be viewed by a client and sent by email e.g. Financial Services Guide of organisation (FSG).

FIG. 31 shows the template generated by the interface process 8 when the account has been successfully created.

### Obtain Bank Details

In order to ensure that transactions are timely implemented, it is very important that the correct bank details are stored on the client data 21 of the database 4. Incorrect bank details or no details can fatally delay deals.

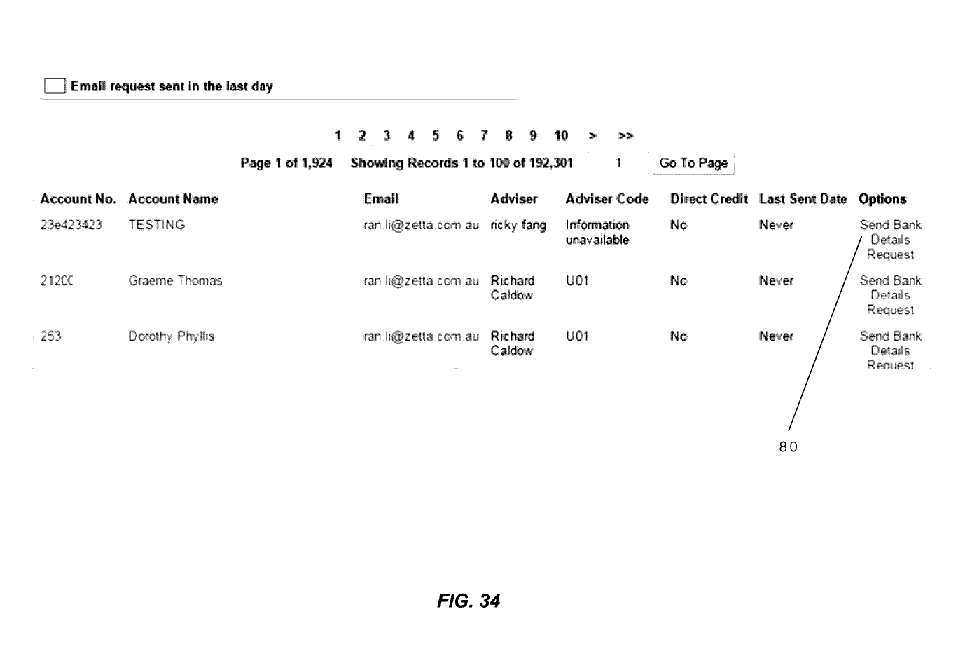

The system 1 has a reports module 307 which is arranged to scan the database 4 and generate reports relating to missing information. One report that may be generated is a report of missing bank details. Part of such a report is illustrated in FIG. 34. The account name and other details are illustrated where there are no bank details. In the Options column 80 it can be seen that a message “Send Bank Details Request” appears. From this report, an advisor may actuate sending of messages to clients via the message engine 14 and communications 18. The message requests some update of bank details. FIG. 33 shows a form which is generated by the message engine 14 in response to the reports module 307 and sent to a client with a covering email.

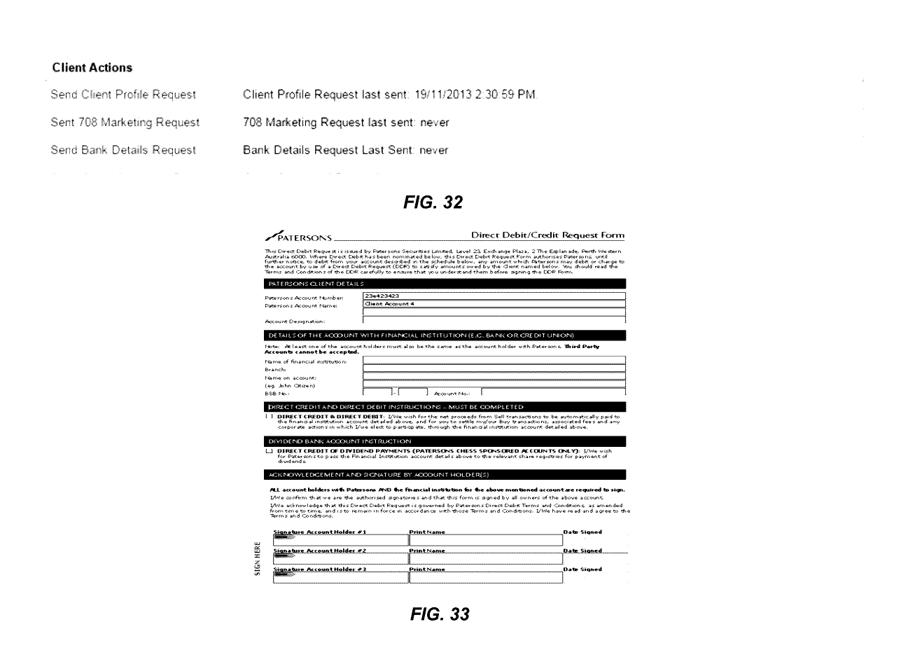

Alternatively, the form of FIG. 33 can be generated from the “Client Actions” interface template generated via interface process 8. An illustration of this is given in FIG. 32.

### Future of Financial Advice (FOFA) and Fee Disclosure Statement (FDS)

In Australia, FOFA rules are enforced and require financial advisors to provide a clear and concise annual report to the client of what fees were charged and what services were provided. Each client that signs up for a service must sign every two years an opt in agreement and must every year be sent an FDS outline of the fees charged for all products that year. As a result a client might have one or more FDSs that must be sent every year and they must sign an “opt in” form once every two years. Similar requirements arise in other jurisdictions.

This embodiment comprises a FOFA module 308. This enables entry of fee disclosure details and also the FOFA status of a client. Regular reminders are sent to financial advisors regarding the annual report required, the “opt in” agreement and FDS requirements.

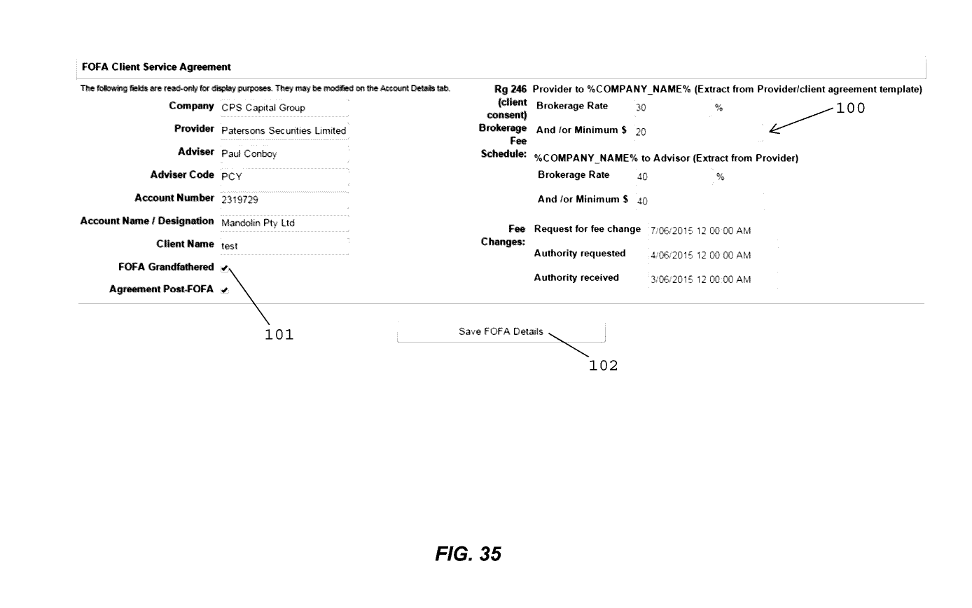

FIG. 35 illustrates an interface template generated by the interface process 8 in response to the FOFA module 308. The advisor is able to enter fees (reference numeral 100). The advisor is also able to designate whether the client is subject to the FOFA regulations or not (if the client is grandfathered—reference numeral 101). Where a client is “grandfathered”, this means that they were a client before the FOFA regulations came into force and they do not need to comply with the opt in requirements. The FOFA details are saved under client data 21 in the database 4 by actuating button 102.

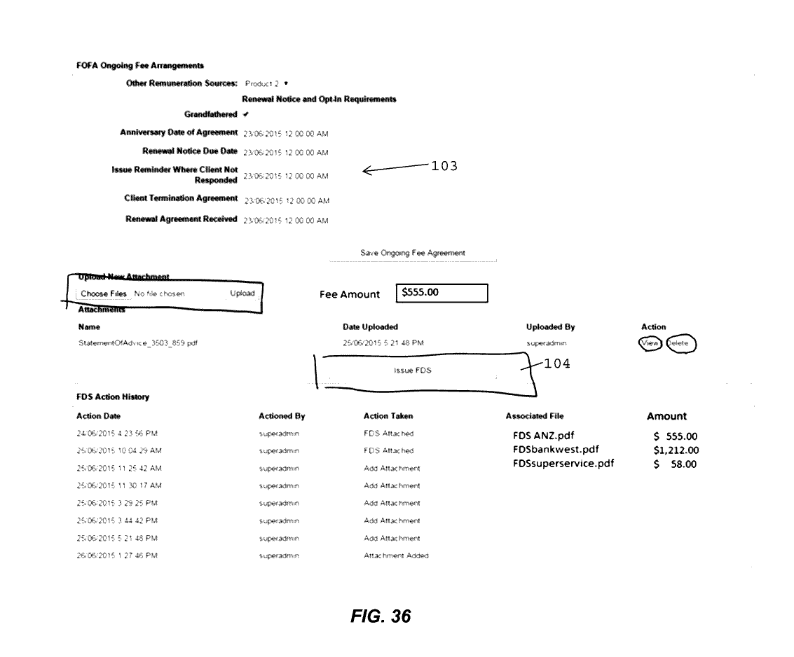

FIG. 36 shows an interface template generated by interface process 8 in response to the FOFA module, which enables setting of anniversary dates for the issuing of renewal notices and opt in requirements (reference numeral 103). It also incorporates an “Issue FDS” button 104 which enables an FDS to be generated and sent to the client via the message engine 14 and communications 18.

The following functionality is implemented by the FOFA module of 308 and system 1.
“Renewal Notice Due Date” called “Anniversary/date of agreement” format as per renewal notice due date.
Requirement to send the FDS at the same time as the opt in notification send electronically and after uploading PDF attachment.
FDS and renewal notice generation. Advisor to be able to load FDS and opt in templates and extract fee data from the database page to merge into templates.
Issue FDS button—required for all ongoing fee arrangements for new and existing clients with ongoing fee arrangements.
FDS and opt in notice to be issued together for all clients with an anniversary date from 1 Jul. 2013.
Able to issue all FDS and opt in a batch on the anniversary date, rather than on an individual generation basis (similar to SoA functionality).
Send copy of FDS via an email via a PDF attachment.
FDS to be issued annually on anniversary date, every 2 years after anniversary date client must receive an opt in notice. The client has 30 days to opt in. The client receives an email and they can check on a link to accept electronically.
Where no acceptance received, issue alert to Compliance/Finance to stop the collection of fees. Notification emails alerting management when electronic acceptance not received on day 5, 10, and 30 of the 30 day opt in period.
Upload functionality “executed ongoing client agreement” for admin to upload scanned copy of signed client agreement if manually signed and not accepted via electronic acceptance.
Audit trail functionality similar to capture all FDS and opt in communications to clients.
Change fee agreement terms field. Where there is a change to ongoing fee arrangement, anniversary date to be reset to date of amended agreement. Audit trial to reflect change.

In the above description and drawings, various trade marks are included. For example, Complii™, Patersons™, and others. The present invention is in no way limited to systems associated with these trade marks, or to use of the trade mark or trade name terminology.

The above description describes embodiments which are particularly arranged for facilitating compliance with the Australian financial regulatory regime. It will be appreciated that the apparatus and method can be arranged and adapted for facilitating compliance with any other regulatory regime.

It will be appreciated that embodiments of the present invention may be implemented by a variety of hardware and software architecture. General purpose computers may be programmed to implement embodiments of the encryption process. Hardware architecture is not limited to general purpose computers or servers, but any architecture could be implemented, including client server architecture, central processing unit terminal architecture, or any other architecture. The system may be implemented utilising mobile devices, such as tablet computers and laptop computers, or dedicated bespoke architecture. Software may be used to program processor(s), to implement embodiments of the invention. Programmable hardware may be used to implement embodiments, such as field programmable gate arrays, programmable gate arrays, and the like.

Where software is used to implement the invention, the software can be provided on computer readable media, such as disks, or as data signals over networks, such as the Internet, or in any other way.

In embodiments, hardware architecture already pre programmed to implement embodiments of the invention may be provided.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

What is claimed is:

1. An apparatus for facilitating compliance with regulatory requirements for financial advisors, comprising a computing device having a processor, a memory and an operating system supporting computer processes, a compliance process arranged to facilitate business processes that facilitate compliance with the regulatory requirements, an interface process responsive to the compliance process for generating interfaces for users, and a message engine responsive to the compliance process for generating messages for communication with users, whereby users can engage with the apparatus to implement the business processes.

2. An apparatus in accordance with claim 1, comprising a Chinese Wall module and a Chinese Wall register, the Chinese Wall module being arranged to place user data in the Chinese Wall register where the user has had access to relevant information.

3. An apparatus in accordance with claim 2, wherein the Chinese Wall module is arranged to control the message engine to generate a confirmation message and send it to the user who is registered in the Chinese Wall register.

4. An apparatus in accordance with claim 3, comprising a device arranged to enable a user to acknowledge that they have received the message and are aware that they are Chinese Wall registered.

5. An apparatus in accordance with claim 2, wherein the Chinese Wall module is arranged to monitor transactions in relation to product(s) or user(s) entered in the Chinese Wall register or associated with the Chinese Wall entry.

6. An apparatus in accordance with claim 5, wherein the Chinese Wall module is arranged to control the message engine to alert person(s) of such transactions occurring.

7. An apparatus in accordance with claim 1, comprising an associated accounts module, which is arranged to locate account data for accounts which are associated.

8. An apparatus in accordance with claim 7, wherein the associated accounts module is arranged to facilitate a change in client data across all associated accounts, and wherein the associated accounts module is arranged to control the message engine to generate a message for the client(s), the message including client data for the associated accounts and a request to confirm the change.

9. An apparatus in accordance with claim 1, comprising an electronic notifications module, which is arranged to facilitate obtaining consent from a client for electronic notification, and to log the consent in memory, the electronic notifications module being arranged to control the message engine to generate a message to send to the client for the client to consent to electronic notification.

10. An apparatus in accordance with claim 1, comprising a strategy module, arranged to facilitate the delivery of strategic advice, the strategy module being arranged to control the interface process to produce interfaces for a user to enter a record of strategic advice in the memory, and wherein the strategy module is arranged to control the message engine to automatically prepare and send reminder messages to clients reminding them that strategic advice is due to be updated.

11. An apparatus in accordance with claim 1, comprising an order advice module, which is arranged to control the interface process to enable entry of records of advice by users and to control the message engine to issue advice(s) documents for clients, and wherein the order advice module is arranged to group individual advices together where they are associated, and to control the message engine to send out the grouped advices together.

12. An apparatus in accordance with claim 1, comprising a Create Account module, which is arranged to facilitate the creation of an account and the presentation of information to the client, the Create Account module being arranged to control the interface process to present interfaces to users to enable the users to enter client data, and to control the message engine to create one or more messages to be sent to the client to provide them with the required advice associated with the opening of the account.

13. An apparatus in accordance with claim 1, comprising a reports module, which is arranged to generate reports relating to missing information, and wherein the reports module is arranged to control the message engine to issue a message to be sent to a client requesting confirmation of client data that may be missing or has been updated.

14. An apparatus in accordance with claim 1, comprising a Fee Disclosure module which is arranged to generate an interface process enabling a user to enter Fee Disclosure details for a client, and to control the message engine to generate Fee Disclosure Statement(s) and send them to the client, wherein the Fee Disclosure module is arranged to control the message engine to generate a message to go to a client, the message including a device enabling the client to confirm that they “opt in” to services.

15. A method for facilitating compliance with regulatory requirements for financial advisors, comprising the steps of implementing a compliance process arranged to facilitate business processes that facilitate compliance with the regulatory requirements, generating interfaces for users, and, responsive to the compliance process, generating messages for communication with users, whereby users can engage with the compliance process to implement the business processes.

16. A method in accordance with claim 15, comprising the step of implementing information barriers within an organisation, providing a Chinese Wall register, placing user data in the Chinese Wall register where the user has had access to relevant information.

17. A method in accordance with claim 15, comprising the step of locating account data for accounts which are associated with each other and, when making a change in client data, making the change automatically across all associated accounts.

18. A method in accordance with claim 15, comprising the step of generating interface(s) for a user to enter a record of strategic advice into a database, and automatically generating reminder messages regarding the need for strategic advice, and transmitting the reminder messages to clients.

19. A method in accordance with claim 15, comprising the step of controlling an interface to enable entry of records of advice by users into a database, generating a message including advice(s) and transmitting the message to client(s), and grouping advice(s) together where they are associated.

20. A method in accordance with claim 15, comprising the step of generating reports relating to missing client data, controlling an interface to present the reports to a user, and generating and transmitting messages to clients requesting confirmation of missing/updated client data.

21. A non-volatile computer readable medium providing instructions for controlling a computer to implement an apparatus in accordance with claim 1.
